(19) United States
(12) Patent Application Publication
(10) Pub. No.: US 2007/0216685 A1
(43) Pub. Date: Sep. 20, 2007

(54) Scene write-once vector and triangle rasterization

(75) Inventors: Ashraf A. Michail, Redmond, WA (US); Christopher N. Raubacher, Seattle, WA (US); Donald D. Karlov, North Bend, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/377,765

(22) Filed: Mar. 15, 2006

(51) Int. Cl. G06T 11/20

(52) U.S. Cl. 345/441; 345/553

(57) ABSTRACT

Described is a rasterizer that processes the graphics primitives of a frame's image to build an array of entries representing which scanlines are affected by which graphics primitives. When built, the array is then referenced to draw the data of more or more combined primitives, e.g., on a scanline-by-scanline basis. Each scanline may be divided into segments defined by the edges of the primitives that affect the scanline, with the segments drawn based on each primitive's drawing data, e.g., including brush information and drawing order. Aliased and anti-aliased rasterizing are described, as is three-dimensional triangle data, and applying effects to groups of primitives.

### BACKGROUND

The traditional model for rasterizing a frame of vector graphics typically involves processing and blending a single graphics instruction (primitive) at a time into a back buffer, and presenting (or blt-ing, sometimes referred to as blit-ing) the back buffer to a display area. However, this model of drawing each primitive one at a time to a back buffer has a number of problems, particularly regarding storage and performance.

For example, when multiple primitives are each directed to writing to the same pixel, that is, when primitives correspond to overlapping pixels, at least some pixels are blended to the back buffer multiple times, sometimes referred to as overdraw, potentially causing performance-related bottlenecks. For example, one primitive may be for drawing a background in one color, another primitive for drawing a differently-colored rectangle that appears in front of that background, yet another primitive for drawing a box such as corresponding to a button within the rectangle, and so forth. Some primitives require reading previous pixel data from the buffer, blending it in some way with corresponding pixel data specified by another primitive, and writing the blend back to the buffer. The blend operations thus often involve read-modify-write operations that are significantly slower than write operations. A typical software application may require three to six passes through the memory, many of which are read-modify-write blends, which are slow. For example, even with simple shapes where memory bandwidth is equal to the speed of the rasterizer, this overdraw factor of three to six is indeed a performance bottleneck, often causing the perceived performance of the application program to be below acceptable levels. For other applications that have more layers and more blending, this overdraw factor can be much larger than three to six times the display area. The blend is even more expensive if the independent objects have complex brushes, materials, or textures.

Another problem results when dealing with format conversion to a destination surface of fewer bits. Doing so requires an extra pass, or results in a loss of precision during blending.

Further, independently drawing primitives while enabling features such as full-scene anti-aliasing often requires a large amount of storage for the back buffer. This extra storage substantially increases the memory usage and the amount of time needed to rasterize. To reduce the amount of memory allocated for the back buffer, tiling techniques may be used, but such an approach increases the number of passes required. For three-dimensional situations, an extra z-buffer is required to store depth information. There is a memory bandwidth cost (and memory cost) to reading and writing to that surface as well.

Other problems with this model result from effects on groups of primitives, such as opacity effects or anti-aliased clipping that typically involve creating temporary surfaces for grouping. For example, consider applying a later-processed opacity-related primitive to pixel data that form a blue rectangle over a red surface. To do this correctly, a rasterizer first needs to treat the blue and red data together as a group, because if handled separately on each piece of data, the opacity would effectively be applied to a purple rectangle. To treat such data as a group, a temporary surface is required, which again takes memory, sometimes substantial memory, and can be extremely slow.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a rasterizer that processes a set of graphics primitives into entries into a vector buffer having an array of entries, with each entry representing a scanline. For each primitive, an entry is made in the vector buffer to point to a data structure associated with that primitive, with a linked-list or the like created when multiple primitives enter on the same scanline. When the vector buffer includes the pointers, the rasterizer walks the entries to determine which primitive or primitives affect a selected scanline, and for the selected scanline, to draw pixels for the scanline by processing drawing information associated with each primitive that affects that scanline.

Thus, by adding data to a vector buffer to represent how one or more graphics-related primitives affect a scanline, the vector buffer may be processed on a per-scanline basis to obtain drawing data corresponding to each primitive, to draw at least a segment of the scanline to a destination surface based on the drawing data, e.g., including brush information and a primitive drawing order. In general, a scanline is selected and drawn, such as by drawing segments determined from where the primitives horizontally start and end on that scanline, and the process repeated for each scanline until an entire image is drawn.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a general-purpose computing environment into which various aspects of the present invention may be incorporated.

FIG. 2 is a representation of an example architecture including a rasterizer that uses data structures to write to each pixel once.

FIG. 3 is a representation of a rendered image made from three primitives that draw rectangles.

FIG. 4 is a representation of example data structures comprising a scanline-indexed array that includes pointers to a linked list of primitive data that the rasterizer uses to process primitives into the segments of scanlines.

FIG. 5 is a representation of the example data structures of FIG. 4 after an additional primitive has been processed.

FIG. 6 is a flow diagram representing example steps to build a scanline-indexed array from the graphics primitives available for a frame.

FIG. 7 is a flow diagram representing example steps that locate the active primitives in a scanline by processing the indexed array.

FIG. 8 is a flow diagram representing example steps that draw brush output for the segment or segments in a scanline based on the active primitives of that scanline.

FIG. 9 is a representation of a rasterizer using data structures to write segments of pixel data to a destination surface.

FIG. 10 is a representation of the primitives of a scanline being processed to develop segments of pixel data for that scanline.

FIG. 11 is a representation of having multiple scanlines for anti-aliased content rasterizing.

FIG. 12 is a representation of a coverage buffer for anti-aliased content having nodes representative of the effective amount that a primitive covers pixels.

FIG. 13 is a conceptual representation of how a three-dimensional triangle texture having a varying z-order may be converted to multiple segments in write-once scanline rasterizing.

FIG. 14 is a representation of the use of layers to provide effects to the segment data with grouped primitives.

### DETAILED DESCRIPTION

Exemplary Operating Environment

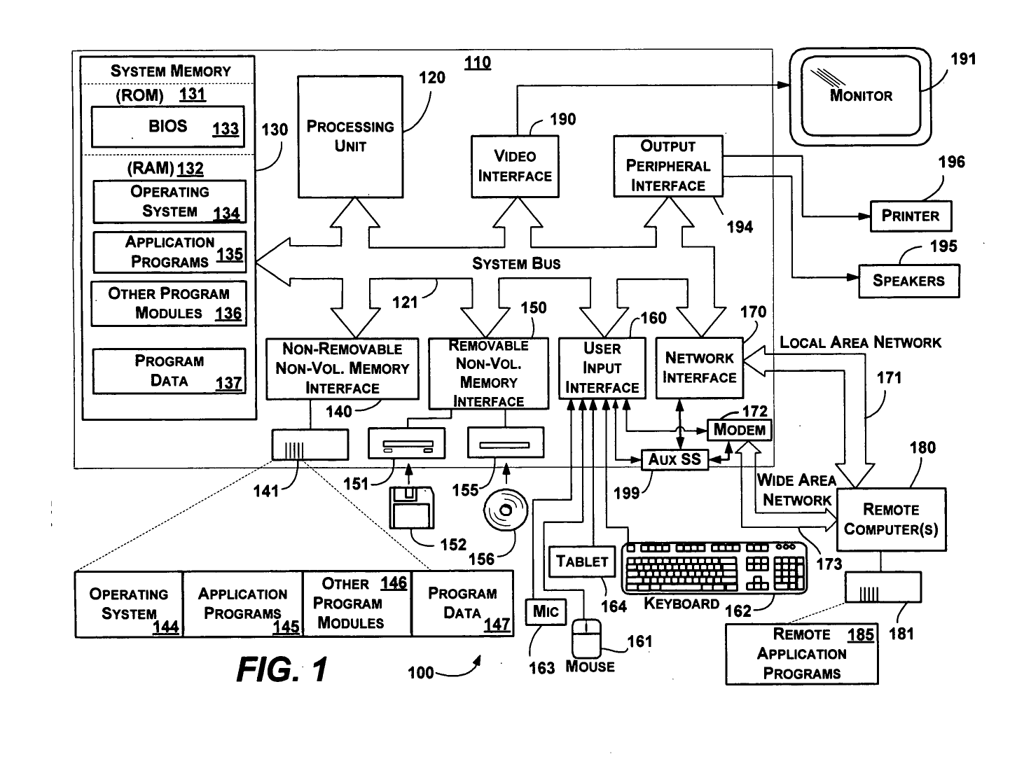

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, described above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It may be appreciated that the network connections shown are exemplary and other means of establishing a communications link between the computers may be used.

An auxiliary display subsystem 199 may be connected via the user interface 160 to allow data such as program content, system status and event notifications to be provided to the user, even if the main portions of the computer system are in a low power state. The auxiliary display subsystem 199 may be connected to the modem 172 and/or network interface 170 to allow communication between these systems while the main processing unit 120 is in a low power state.

Write-Once Vector and Triangle Rasterization

Various aspects of the technology described herein are directed towards a technology by which a rasterizer combines information from graphics primitives prior to writing any pixel such that each pixel need be written only once to a back buffer, and indeed may instead be written directly to video memory or the like. As a result of combining the primitives' information, many of the existing problems with conventional rasterizing are solved, including requiring no additional storage (or at most a single back buffer), and eliminating overwriting, greatly improving performance. Note that the technology is applicable to sub-pixel output as well.

While significant benefits are achieved in efficient and high-quality display output, the mechanisms described herein can also be used to enable efficient printing of content. As described herein, because the process eliminates overdraw/overlap, it removes the need for excess memory or difficult composition on the printer. Indeed, any technology that processes instructions or the like to write bits (or sets of bits) to an output surface such as a memory may benefit from the concepts described herein.

One solution described herein accomplishes write-once rasterization by building a data structure or structures that enables the rasterizer to determine all paths/triangles (including materials/brushes/textures) that contribute to a particular pixel. With this data structure, the rasterizer can conceptually walk each destination pixel exactly once, independent of the complexity of the scene being rendered. As described below, for each pixel, the rasterizer may compute a destination color by performing the appropriate math on the sources that contribute.

In one example implementation, the computed color is determined and written out, and the rasterizer advances to the next pixel. The process is repeated for each horizontal line (scanline) of pixels to be written out, and the scanlines may be processed in any order, although typically they would be processed from the uppermost scanline to the lowest scanline. Note that because scanlines are processed, (as opposed to writing and possibly blending the result of each primitive), multiple processors can easily be arranged perform these computations in parallel, by simply dividing up the scanlines to be handled by each. For example, this technology may be implemented on multiple-core processing units, by having different cores work on different scanlines.

While the example rasterizer described herein thus outputs pixel data via horizontal scanlines, typically from top to bottom, it is equivalent to have a rasterizer arranged to process pixels in vertically lines, and, for example, move to the next vertical line, such as left to right. This may be valuable, for example, such as by being more efficient in a model where a display is arranged to show its output in a portrait orientation instead of a landscape orientation, or vice-versa. The concepts described herein thus apply to any orientation of a scanline.

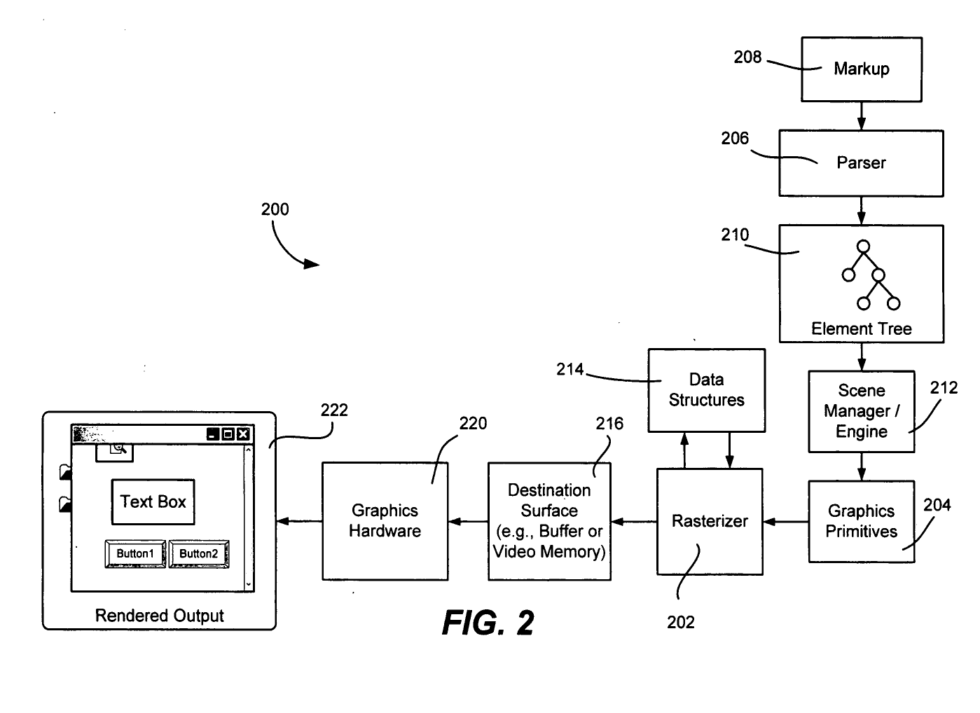

Turning to FIG. 2, the input to the rasterizer 202 comprises a set (e.g., a list) of graphics primitives 204 to be drawn for a single frame of rendered graphics information. In the example implementation of FIG. 2, a retained graphics system is provided, in which the primitives are in some data structure (e.g., represented by the graphics primitives block 204) and can be iterated. For example, In FIG. 2, a retained graphics system may include a parser 206 that parses a set of markup 208 into an element tree 210 that is then traversed by a scene manager/engine 212 to produce the set of graphics primitives 204 for a frame. For immediate mode systems, the primitives can be retained as they come in, and a sample approach may also apply.

As described below, the rasterizer 202 includes a mechanism, comprising an algorithm that walks the primitives and builds up one or more data structures 214 in order to obtain the pixel data for each, such that the pixel need only be written once to an output destination surface 216, e.g., to video memory, to AGP memory, and/or to a system memory back buffer. Shown for completeness in FIG. 2 is the graphics hardware 220 that outputs the pixel data from memory into a visible display 222, e.g., blt-ing a back buffer at the frame rate or the like.

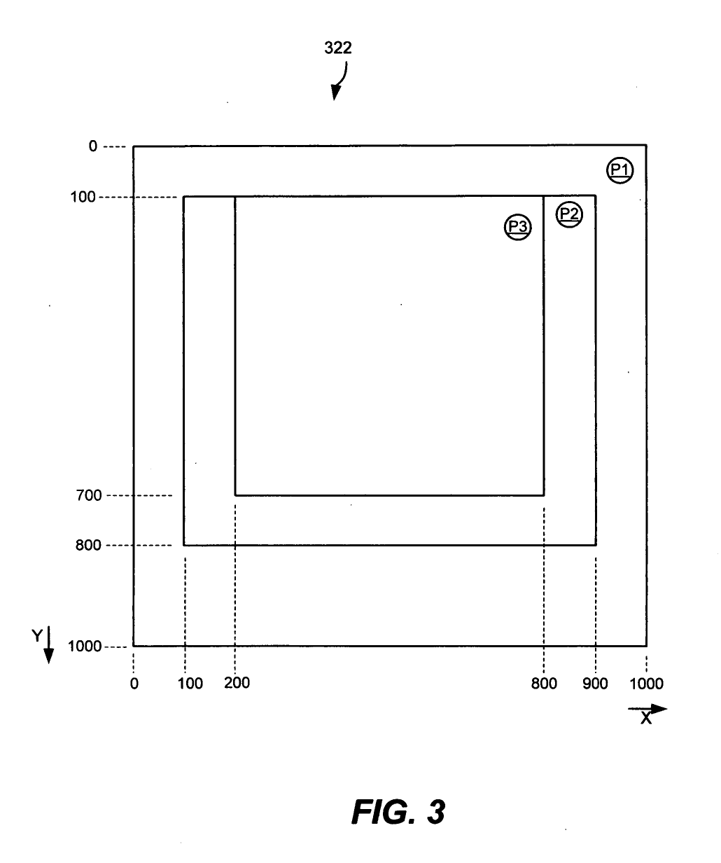

By way of a straightforward example, consider the rendered image 322 represented in FIG. 3. In this example, a first primitive P1 draws a rectangle (labeled P1 in a circled label which is not part of the image) that spans from horizontal (X-coordinates) 0 to 1000, and from vertical coordinates (Y-coordinates) 0 to 1000; (note that in this example, the Y-values of the pixels increase from top to bottom). The primitive includes brush information that will render this rectangle as light gray, for example, as in FIG. 3. Note that in FIG. 3, the rectangles are represented as having black borders for purposes of contrasting the rectangles in this black-and-white representation, however these borders may not be present in an actual image where colors can provide the needed contrast.

Continuing with the example, a second primitive P2 draws a different, white-colored rectangle (labeled P2 in a circled label which is not part of the image 322) that spans from horizontal (X-coordinates) 100 to 900, and from vertical coordinates (Y-coordinates) 100 to 800. Because the primitives are in order, the rasterizer knows to draw this primitive P2 rectangle over the P1 rectangle. It is alternatively feasible in two-dimensions to have a z-order with each primitive that can be sorted to get them into a desired order. As also represented in FIG. 3, a third (slightly different shade of gray) rectangle corresponding to a primitive P3 is to be rendered atop the other two rectangles, ranging from X-values 200 to 800 and Y-values 100 to 700.

As described above, a conventional rasterizer would separately draw to a buffer for each primitive, overwriting P1 with P2 where they overlap, and then overwriting P2 with pixel data based on primitive P3. Also, P3 would have to overwrite P1's pixels, if, in a modified example to that of FIG. 3, P3's rectangle did not entirely fit within P2's rectangle. Even in the simplified example of FIG. 3, there would be three passes required, and some pixels would be written and re-written a total of three times. If any of the primitives included effects such as opacity that required blending, the underlying pixels would have to be read back, modified with the data of the primitive currently being processed, and then written back. For example, if some blending of P1 and P2 occurred, P3 would also need to overwrite the blend, which would include P1's contribution to the blend.

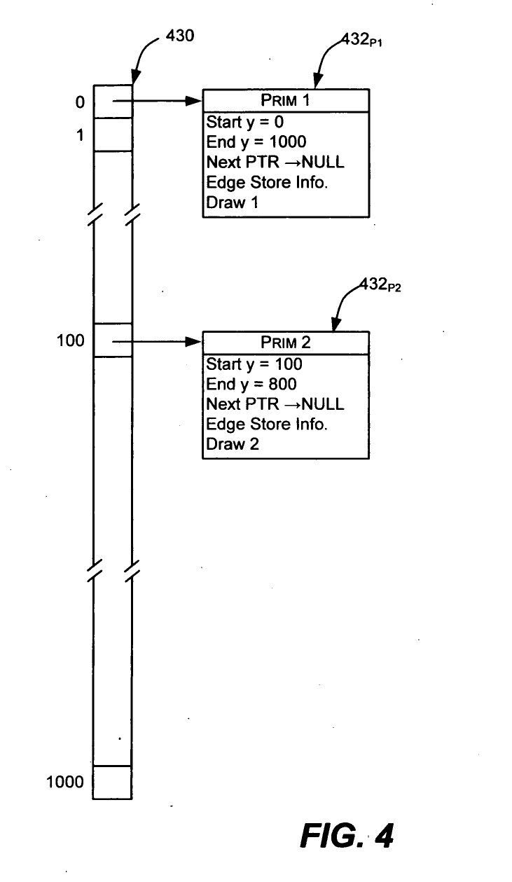

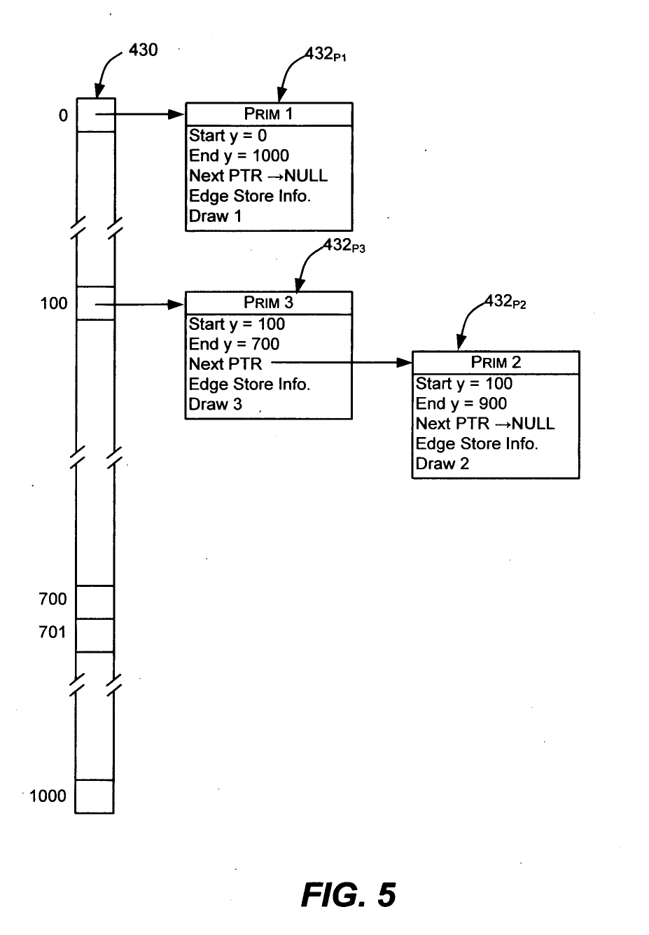

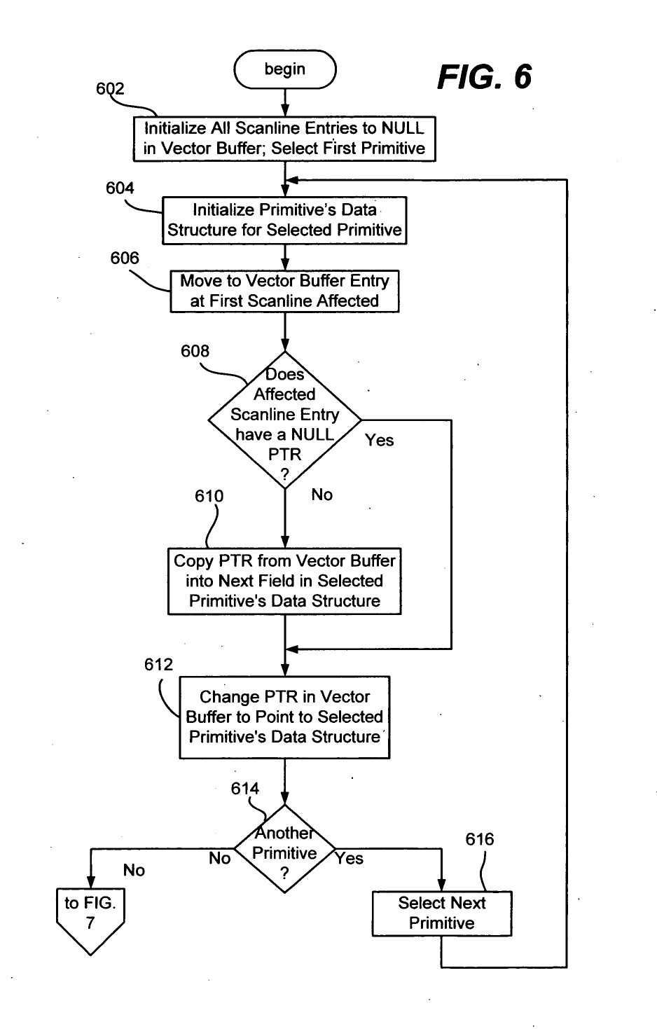

In contrast, the rasterizer 202 described herein processes the primitives in a manner that allows each pixel to be written once and only once to the destination surface 216 (FIG. 2), including with no read-modify-write operations required for any blending. An example of how a suitable write-once algorithm in the rasterizer 202 can process a set of primitives, in this example the primitives corresponding to the image in FIG. 3, is represented by the diagrams of FIGS. 4 and 5 and the flow diagram of FIG. 6.

In general, the rasterizer 202 walks each primitive in the set 204 to be drawn for a frame, and for that primitive, adds an entry to a scanline-indexed data structure (e.g., array) referred to herein as a vector buffer 430 (FIG. 4), where as described above, a scanline (typically) corresponds to each Y-coordinate of a display and (typically) ranges through all of the X-coordinates. Thus, using the example of FIG. 3, the first scanline corresponds to a Y-value of 0 and ranges from X-values of 0 to 1000, the second scanline corresponds to a Y-value of 1 with the same 0 to 1000 X-range and so forth, up to a scanline corresponding to a Y-value of 1000. The vector buffer 430 represented in FIG. 4 thus comprises an array having 1001 entries for (Y-values 0 to 1000).

In the example of FIG. 4, the entry for each scanline in the vector buffer 430 comprises a pointer to another data structure (e.g., 432_{P1}) that contains various data corresponding to the primitive P1 that potentially affects that scanline. The affected scanline or scanlines are known from the data of each primitive, as maintained in that primitive's data structure (also referred to as a path object) via the start-y and end-y values.

As multiple primitives may affect a scanline, one suitable mechanism used to track how primitives are ordered with respect to one another is a linked list, where the vector buffer 430 points to the primitive's data structure of the most recent primitive that affected that scanline, with the primitive's data structure pointing to the next most recent primitive data structure, and so forth until no other such primitive exists (NULL pointer). Other mechanisms are feasible, (such as by linking from the next most recent to the most recent, instead of from the most recent the next most recent).

Using the example of FIG. 4, after two primitives P1 and P2 (corresponding to the primitives that created example image of FIG. 3) have been processed, scanline 0's entry in the vector buffer 430 points to the data structure 432_{P1} (for primitive P1), because at this time during the walk through the set of primitives, the only primitive that affects scanline 0 is the primitive P1. Note that although the primitive P1 affects scanline 1, only the entry corresponding to the scanline where the primitive P1 enters gets the pointer, and thus the entry for scanline 0 gets the pointer but not the entry for scanline 1, which remains NULL.

When the primitive P2 is processed, P2 also affects the scanlines starting at scanline entry 100. This is the state represented in FIG. 4.

FIG. 5 shows a later state of the vector buffer 430 and primitives' data structures, in which P3 has been processed. At scanline entry 100, P3's data structure 432_{P3} is essentially inserted by having the scanline entry 100 point to P3's data structure 432_{P3}, which in turn points (links) to P2's data structure 432_{P2}. To this end, the pointer for scanline entry 100 in the vector buffer 432 that pointed to the primitive P2's data structure 432_{P2} is moved into P3's data structure's “Next” field, and the entry in the structure 430 is changed to point to primitive P3's data structure 432_{P3}.

All other primitives are similarly processed in order, until none remain, which in this example is only P1-P3. The result is a set of rasterizer paths, containing at least one primitive's data structure possibly linked to one or more additional primitive's data structures.

FIG. 6 is a flow diagram summarizing these example steps of filling the vector buffer 430 with pointers to the primitives' data structures, beginning at step 602 when the primitives for a frame have been received, and are in order. Step 602 represents initializing the scanline entries in the buffer to NULL, and selecting the first primitive.

Step 604 initializes the data structure of the selected primitive, e.g., including to compute the start and end y-values that correspond to a range of scanlines, based on the drawing data (e.g., the geometry and starting coordinates) associated with the primitives. Other information that may be copied into the primitive data structure includes data such as brush-related information (e.g., solid/gradient and color data), effects data and so forth, although this information may be obtained from the primitive at a later time. Note that a vertical gradient may be treated as a solid color for that scanline, that is, it does not vary horizontally.

Steps 606, 608 610 and 612 represent setting the pointer in the vector buffer's entry for the current scanline to point to the selected primitive's data structure, preserving any prior pointer data at step 610, that is, by creating a linked list as necessary. First, step 606 moves to the entry location where the selected primitive enters on a scanline. Step 608 determines if there is a NULL at this entry location; if not, there is a pointer to another primitive's data structure, and step 610 copies this existing pointer into the Next field of the selected primitive's data structure to maintain the linked list. Then at step 612 the process writes the pointer to the selected primitive's data structure over that now-copied entry into the vector buffer 430. Note that if at step 610 the pointer was NULL, step 610 is bypassed to write the pointer to the selected primitive's data structure over the NULL at step 612.

When a given primitive is handled in this manner, steps 614 and 616 select the next primitive as the selected primitive and loop back for similar processing for that primitive's first affected scanline, until all primitives have been handled. Thus, in the example of FIG. 3, the three primitives P1-P3 will be handled in order, resulting in the state represented in FIG. 5.

Once the primitives are processed, the vector buffer 430 contains the pointers that point to the primitives' respective data structures, that each in turn will include a pointer to another primitive's data structure when necessary, forming a linked list. At this time, the scanlines can be built using the data of any primitive that affects the scanline.

In one implementation, the primitives are merged into a single list, as the rasterizer 202 performs a scanline walk, to make segments as described below. The current scanline has a list of “active primitives” that are kept in draw order.

For example, a vector buffer may be stored as set forth below, forming a structure that is linked and scanline indexed, (where AddPath corresponds to inserting a link in the scanline in which the path begins; this insertion is a fast constant time operation):

class CFrameVectorBuffer
{
public:

//
// Create
//
static HRESULT Create(INT cScanlines, CFrameVectorBuffer
**ppVectorBuffer);
//
// Empties the vector buffer
//
void Reset ( );
//
// Adds a path to the vector buffer
//
void AddPath(RasterizerPath *pRasterizerPath);
//
// Rasterize the frame
//
HRESULT RasterizeFrame(

DWORD dwBackgroundColor,
IDrawEngine *pEngine
);

private:

//
// Scanline indexed vector buffer
//
// Scanline y has a pointer to a Rasterizer path
// if and only if it begins on that scanline.
//
RasterizerPath** m_ppVectorBuffer;
//
// Number of scanlines in the frame
//
INT m_cScanlines;

};

As should be understood, the vector buffer 430 allows multiple paths to be added in draw order, one at a time. As described below, once the paths are known, a list of path segments needed for a specific scanline are obtained. The scanline-indexed array of path pointers described via FIGS. 4-6 has each entry in the array point to a path (and only the path) that starts on that scanline, and each primitive data structure in the path has a “next” pointer that can be used by the vector buffer. Note that although the draw order can be inferred via link order for a single vector buffer entry, each path may have a “draw order” number that preserves the original draw order when those paths are merged into an active path list. If, as in the example described above, the rasterizer inserts during a draw-ordered walk, the scanline lists are already sorted by draw order, which can be advantageous for faster merging into the active path list.

Assuming four byte pointers, the vector buffer costs four bytes per scanline (i.e., 4 k for 1,000 scanlines) and eight bytes per path object of memory. The flattened edge store is usually retained independently of this algorithm to avoid flattening/widening of paths on every frame, so its cost is not included here. However, if the flattened edge store is not retained in a particular rendering system, it can be generated when a path enters a set of scanlines, and destroyed when it leaves.

When the vector buffer 430 including its paths is prepared, the rasterizer 202 sweeps, e.g., from the top scanline to the bottom scanline, knowing which paths enter on each scanline. With this information, the rasterizer 202 walks from top scanline to bottom, and knows the paths that intersect each scanline by merging the paths from the previous scanline with those from the current scanline. Note that the rasterizer also needs to remove paths that have already completed rasterization in this process.

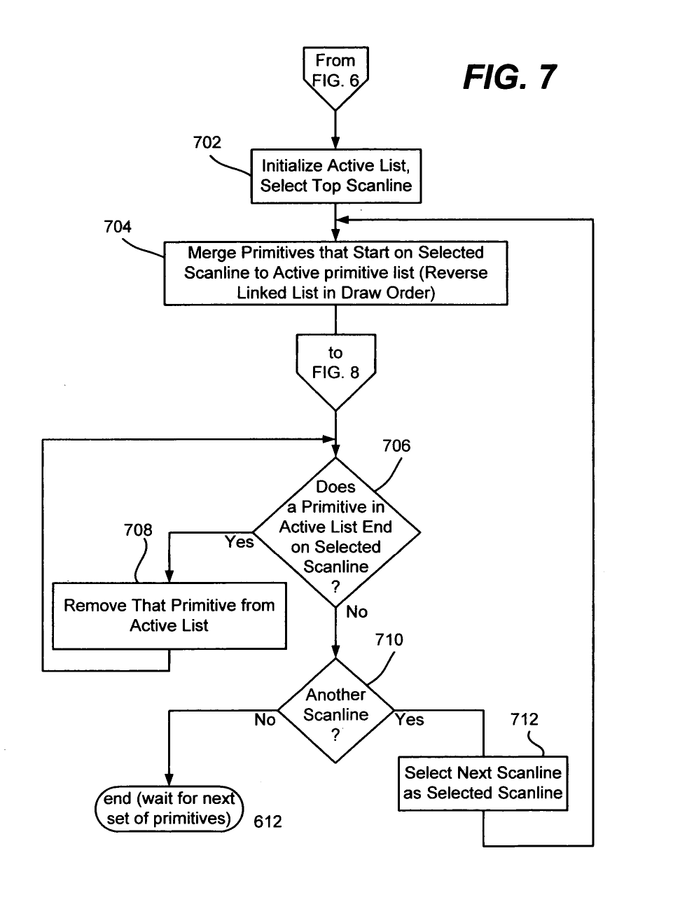

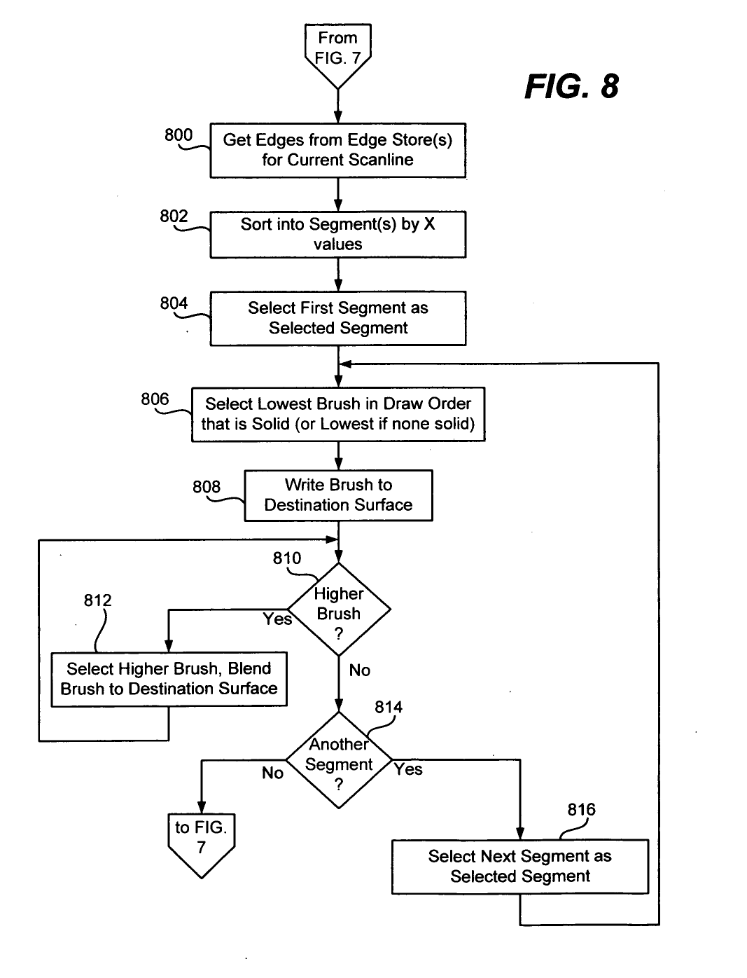

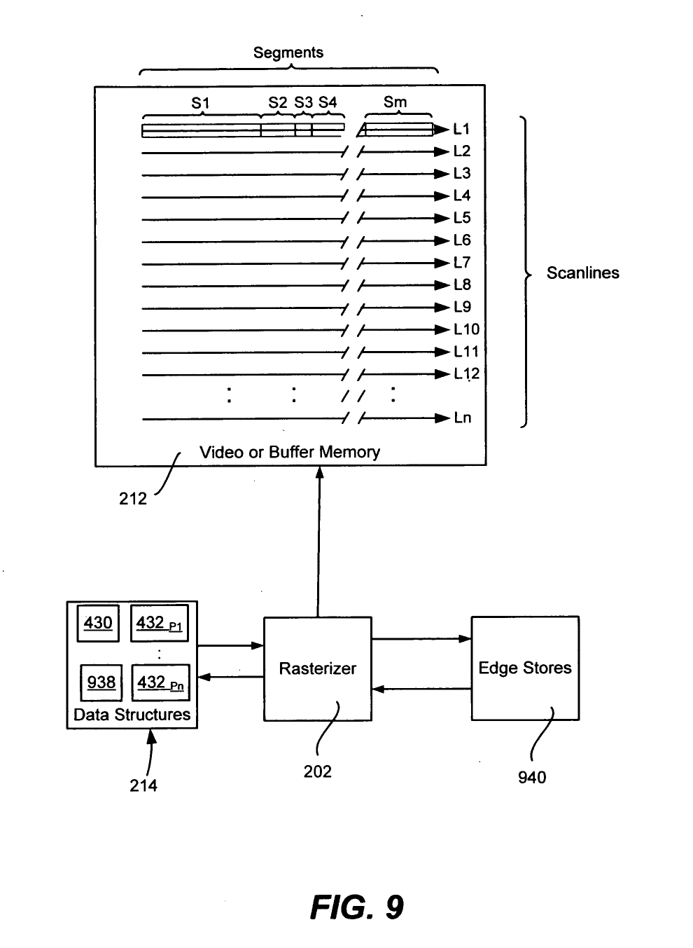

FIG. 7 exemplifies this scanline walk and merge process, beginning at step 702 which represents selecting the uppermost scanline and performing any needed initialization of the active list 940 (FIG. 9) of primitives. Using the paths, step 704 merges an identifier of each primitive that starts on the current scanline with the active list, which if continuing with the example of FIGS. 3-5, is only be the P1 primitive for the first scanline (scanline=0). With this list of paths for a scanline, the rasterizer 202 can write out the pixel data, as generally described below with reference to FIG. 8.

Steps 706 and 708 remove any primitive that ends on the currently selected scanline from the active list 940. Step 710 and 712 repeat the process for the remaining scanlines to be walked. Thus, in the example of FIGS. 3-5, scanlines 0 through 99 would only have the primitive P1 associated therewith, however scanline 100 would merge primitive P3 and P2 with P1 and thereby scanline 100 will need to handle these three primitives. Note that P3 would be removed from the active list 938 after processing scanline 700, (leaving P1 and P2 in the active list 938), and P2 would be removed from the active list 938 after processing scanline 800, leaving only P1 from scanlines 801-1000, after which the active list would be empty. Also note that the draw order is maintained if there are multiple primitives per scanline, e.g., by the reverse order of the linked list.

Once the rasterizer 202 knows the paths for a particular scanline, the rasterizer 202 also knows the edges for that scanline. More particularly, each primitive has an associated edge list 940 (FIG. 9) to which its primitive data structure has a pointer, which contains the information as to where on the X-coordinate or coordinates the primitive intersects that scanline. In one implementation, each path has a per-path flattened edge store 940 cached for that path to track and retain the set of edges that intersect the current scanline when that scanline is being rasterized. As edge stores are well known components (e.g., used in conventional per-primitive rasterizing technologies), edge stores will not be described in detail here except to note that segments for each primitive are thus obtained.

Edges are kept on the path in y-sorted order, and can be linked during the vertical sweep, so the rasterizer only needs to advance and update edges for the paths as the rasterizer advances a single scanline.

Once the rasterizer knows the edges for a particular scanline, the rasterizer then needs to rasterize. For aliased content, this may be accomplished simply by sorting the edges for a current scanline by x-value, tracking brush data, and walking from left to right writing pixels, as described below via the flow diagram of FIG. 8. For purposes of the present description, an aliased rendering scenario will be described first, in which each scanline is built from segments defined by simple edges.

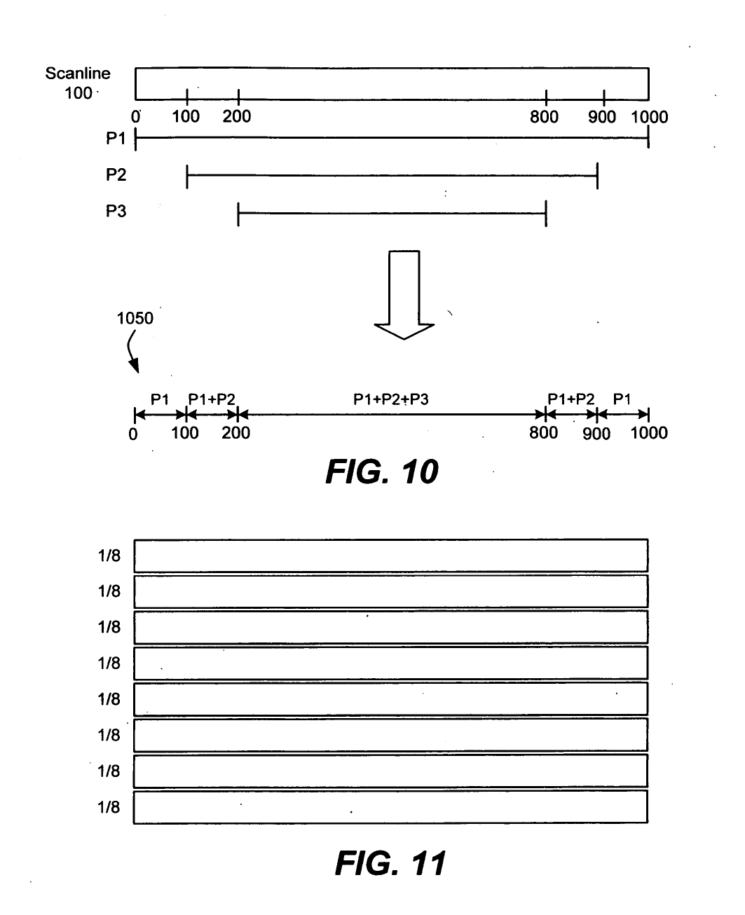

Given that the rasterizer 202 knows the sets of edges for each scanline, when returning to the example of FIG. 3, it is seen that when scanline 100 is reached, the edges are known to be at 0, 100, 200, 800, 900 and 1,000, as conceptually represented in FIG. 10 by the line segments to the right of P1-P3; the primitive ordering is maintained, as well as which primitive is associated with each segment. This forms a set of segments that make up the scanline, where each segment has some computable or otherwise determinable relationship among its pixels based on the data of the primitive or primitives that apply to that segment. For example, the simplest segment would be a set of adjacent pixels of the same color, while a more complex segment would be one that varies (e.g. linearly or according to some other function) from one color to another, and may blend data among primitives. A brush stack may be built to contain the brush data of a segment, e.g., with one set of brush data for each primitive that contributes to the segment, containing information such as solid, opacity (alpha), invisible, color, gradient type information, if any, and so forth. The brush may comprise an object that includes methods, including one to generate its color or colors into memory. Note that invisible brush data can be simply removed.

As represented in the combined segments 1050 of FIG. 10, a first segment exists from 0 to 99, with output data only that corresponding to the brush data of P1. As described below, there is nothing to blend for this segment, and thus the pixel values for this segment are straightforward to determine or compute from the data obtained from the primitive P1, e.g., the brush stack contains P1's brush data.

The next segment, from 100 to 199, is a combination of P2's data with P1's data, with P2's data known to be atop P1's data. Any alpha blending will require that the brushes from each be mathematically combined. However, for single color brushes, the computation can be done for only the first pixel with a result that applies to the rest of pixels for that segment, providing efficient computations. Also for efficiency, occluded brush data is not drawn; since the brush stack represents all the brushes for a segment in the frame, the rasterizer simply stops processing brushes when the rasterizer hits a completely solid brush with no alpha data.

FIG. 8 exemplifies the various per-scanline operations, with step 800 representing obtaining the edges for the currently-processed scanline, and step 802 representing the sorting into segments by the X-values for the primitives. Step 804 selects the first segment.

Step 806 represents selecting the lowest brush that is solid (has no opacity), based on the draw order, or the selecting of the lowest brush if none are solid. This step essentially selects the lowest brush that need be drawn, because nothing will appear below a solid brush. Steps 810 and 812 blend any higher brush or brushes with the lowest brush that was drawn, until none remain and that segment is drawn. When the segment is complete, steps 814 and 816 repeat the process for any other segments.

In the example of FIG. 3 using scanline 100, and as represented in FIG. 10, there is a segment from 0 to 99 that has P1's brush data, a segment from 100 to 199 that includes P2's brush data atop P1's brush data, a segment from 200 to 799 that includes P3's brush data atop P2's brush data atop P1's brush data, and so forth, with the other segments shown being from 800 to 899 (P2's and P1's data combined), and 900 to 1000 (P1's data only). As can be understood from FIG. 8, the segment from 200 to 799 mathematically combines the brushes of P3 atop P2 atop P1 (stopping before processing any occluded brush data, as described above). For example, if P3 is solid, only P3's brush data is used, e.g., there is no reason to consider P2's data or P1's data if P3 occludes the combination anyway. However if not solid, P3 needs to be blended; P2 may be a solid, in which case there is no reason to blend P2's data with P1's data, but if not, the brushes from all three need to be blended.

It should be noted that the blending can occur in various ways. For example, if the destination surface is a back buffer, then the blending can be performed simply by writing the lowest brush to the appropriate location in the back buffer memory, writing the next lowest brush over it and so forth, until no brushes remain to be blended and the process can move to the next segment (or next scanline if completing the last segment). Again, if the brush data corresponds to a single solid color, this blending computation can be done once and the result extended to the rest of the segment. However, two or more transparent gradients will require computing over the various segments' pixels. Note that if the ultimate destination surface is in video memory, a scratch scanline is used for the blending, essentially as a one-line back buffer, so that temporary writes and blends while filling the segment with combined pixels are not temporarily visible. Instead, the scratch scanline's pixel data are copied to video memory when the blending is complete.

The above description was primarily directed towards a single processor handling all of the scanlines with respect to building the vector buffer, although it is understood that as mentioned above, any number of processors can then rasterize the scanlines. However, multiple processors/a multiple-core processor can provide additional efficiency, not just in rendering a subset of the scanlines from its corresponding subset of the vector buffer, but in an alternative implementation by building its own scanline data and/or vector buffer data. By way of example, if a processor processes the primitives to determine which primitive affects a given scanline, (including those that do not necessarily start on the scanline), then that processor may draw as little as a single scanline, without any need to know and merge what was above it. In other words, each processor would just process the set of primitives to determine which primitive or primitives affected (and not just entered) that processor's corresponding scanline or scanlines, and draw as described above. Note that in an implementation where each processor handles a subset of scanlines, (e.g., one processor handled scanlines 100-200), the processor can determine from the primitives which one(s) entered or affected the processor's highest scanline, e.g., entered at 100 or entered above 100 without ending above 100, and then use the “entry-only” technique for primitives that first enter at lines 101-200.

While the above mechanism for aliased content is thus relatively straightforward to implement, for anti-aliased content such as for sharpening diagonal and curved lines, there are several edge-related situations that require additional processing. In general, edges may be present between the pixels of a scanline; edges may end in the middle of scanline, so there is not a unique edge order for a specific scanline, edges may begin in the middle of a scanline and edges may cross and reorder.

To handle anti-aliased content, typically only the edges are drawn anti-aliased, with aliased content drawn between the edges. With the rasterizer described herein, full scene anti-aliasing may be accomplished by use of sub-scanlines, with weighted contributions from the edges of adjacent segments mathematically combined into a single resultant pixel value. For example, with 8×8 anti-aliasing, eight sub-scanlines can be built as in FIG. 11, and then those sub-scanlines mathematically combined into a single scanline, e.g., a one segment having an edge halfway between two adjacent pixels may contribute half to the resultant adjacent pixel values.

In an alternative implementation, a coverage buffer is used by the anti-aliased rasterizer, wherein the coverage buffer indicates how much a pixel is covered by an edge. The path edges are thus rasterized at the anti-aliasing resolution into a coverage buffer containing the anti-aliasing information.

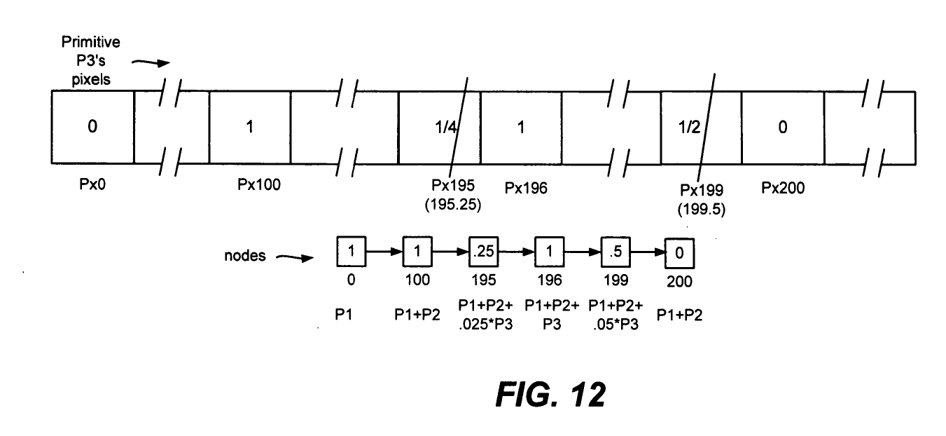

As represented in FIG. 12, the coverage buffer is a virtual (often linked-list) representation of nodes or the like containing the anti-aliasing information for a particular scanline of a path. Each node indicates how much of a primitive covers a pixel, e.g., 0 for no coverage, 0.25 for one-quarter coverage, 0.5 for half coverage, 0.75 for three-quarters coverage, and 1.00 for full coverage. Thus, for example, at pixel 195 it is known that the edge of primitive P3 is at (approximately) 195.25, meaning that the primitive P3 only covers three quarters of that pixel. Nodes are maintained only where an edge transition occurs. Then instead of walking segments as described above, the rasterizer walks the nodes to determine how to rasterize. When walking the nodes, the path data is added to a virtualized color buffer for the scanline that contains the brush, material, and z-order information. The virtualized color buffer is walked to fill in scanline pixels for the destination surface or display area. Opacity blending may be simulated, e.g., pixel 195 would be the same as P3 over P2 over P1 where P3 was blended as if it had an opacity of 0.75.

Note that the rasterizer already has a coverage buffer data structure (used for standard anti-aliased vector rasterization) that can accurately resolve the sub-pixel detail for a single path as well as the other situations mentioned above. As a result, to rasterize a scanline, the rasterizer computes the coverage buffer for each path (for the portion that intersects the current scanline) and adds it to a virtual color buffer that has the instructions needed to rasterize a scanline.

More particularly, an example frame rasterization function comprises:

XRESULT
CFrameVectorBuffer::RasterizeFrame(

_in XUINT32 dwBackgroundColor,
_in XUINT32 nWidth,
_in XUINT32 nHeight,
_out XUINT8 *pbSurface,
_in XUINT32 uStride,
_in XUINT32 cbBufferSize
)

{

XRESULT hr = S_OK;
XINT32 nSubpixelYCurrent = 0;
XINT32 nSubpixelYNext;
CColorBuffer m_colorBuffer;
//
// Init the color buffer
//
IFC(m_colorBuffer.Init(nWidth, dwBackgroundColor));
//
// Setup the anti-aliased filler
//
{

CAntialiasedFiller filler(

pbSurface,
uStride,
0,
nWidth
);

//
// Rasterize each scanline in the frame
//
for (XUINT32 i = 0; i < nHeight; i++)
{

// Advance a scanline. Note that advancing produces a
// draw order sorted list of paths by merging entering paths
// with paths from the last scanline. This process also drops
// paths that no longer intersect the new scanline.
IFC(AdvanceScanline( ));
nSubpixelYNext = nSubpixelYCurrent + c_nShiftSize;
//
// Reset color buffer
//
m_colorBuffer.Reset( );
//
// For each path in the list, generate virtual coverage buffer
// data
//
for (CRasterizerPath *pPath = m_pCurrentPathList;

```
  pPath != NULL;
  pPath = pPath−>m_pNext)
```

{

XUINT32 dwColor;
filler.RasterizeScanline(

pPath−>m_pRasterizerData−>m_pActiveEdgeList,
pPath−>m_pRasterizerData−>m_pCurrentInactiveEdge,
pPath−>m_pRasterizerData−>m_nSubpixelYNextInactive,
MAX(nSubpixelYCurrent, pPath−>m_nSubpixelYTop),
MIN(nSubpixelYNext, pPath−>m_nSubpixelYBottom),
XcpFillModeWinding
);

```
  if (pPath−>m_pBrushSpan−>SolidColor(i, &dwColor))
  {
```

//
// Add solid color data for the scanline
//
m_colorBuffer.AddScanlineDataColor(

dwColor,
&filler.m_coverageBuffer
);

}
else
{

//
// Add complex brush data for the scanline
//
m_colorBuffer.AddScanlineDataBrush(

pPath−>m_pBrushSpan,
&filler.m_coverageBuffer
);

}

}
//
// Rasterize the color buffer and output color data to
// the back buffer.
//
m_colorBuffer.Rasterize(

reinterpret_cast<XUINT32 *>(pbSurface),
nWidth,
i
);

//
// Advance to next scanline
//
nSubpixelYCurrent = nSubpixelYNext;
pbSurface += uStride;

}

}

Cleanup:

return hr;

}

The color buffer is also a virtual buffer that contains entries on the order of the edge-complexity of the scanline. Conceptually, the color buffer is just a list of instructions indicating how to fill a scanline. As paths are visited, their anti-aliasing information is computed in a virtual coverage buffer which is merged (with brush information) into the virtual color buffer. An example color buffer implementation is set forth in the below linked list of non-overlapping segments representing a scanline of color data:

//-------------------------------------------------------------------------
//

| | | |
|---|---|---|
| // | Struct: | ColorBufferEntry |

//

| | | |
|---|---|---|
| // | Synopsis: | Linked list entry in the color buffer |

//
//-------------------------------------------------------------------------
struct CColorBufferEntry
{

| | |
|---|---|
| XINT32 m_nX; | // scanline x position |
| XUINT32 m_dwColor; | // solid color for the span segment |
| CColorBufferBrushSpan *m_pBrushSpan; | // a brush blend stack |
| CColorBufferEntry *m_pNext; | // linked list next pointer |

};
//+------------------------------------------------------------------------
//

| | | |
|---|---|---|
| // | Struct: | CColorBufferBrushSpan |

//

| | |
|---|---|
| // | Synopsis: |

| | |
|---|---|
| // | The structure used for multiple brush bitmap/gradient blending with |
| // | the write-once rasterizer. It keeps the brush stack for the current |
| // | position. |

//
//-------------------------------------------------------------------------
struct CColorBufferBrushSpan
{

| | |
|---|---|
| XUINT32 m_uColorUnderneath; | // The color underneath the brush span |
| XUINT32 m_uBrushAlpha; | // Alpha value to blend the brush with |
| IBrushSpan *m_pIBrushSpan; | // The brush span to blend |
| CColorBufferBrushSpan *m_pNext; | // Next color buffer brush span |

};

Note that the color buffer linked list would have increasing x-values and conceptually represent a list of non-overlapping segments to rasterize. By keeping the color buffer as a list of segments, the rasterizer has a number of advantages, including that the blending of solid colors is done on edges of spans rather than per-pixel. Further, as described above, occluded brush data is never drawn, as brush processing halts when the rasterizer hits a completely solid brush with no alpha data.

Moreover, since the color buffer stores the path data for a single scanline for a frame, the rasterizer is guaranteed at most one write to the destination surface 216. The write once rasterizer 202 has a number of advantages over other models, including the elimination of overdraw, as well as being able to write to any destination surface including video memory, AGP memory, or a system memory back buffer. More particularly, because of writing only once to each pixel in surface scanline order, it is reasonably efficient to draw directly to video memory since the rasterizer has no costly read (for read-modify-write type) operations and only one write. The rasterizer can also write directly to the primary display surface without structural tearing. Still further, because the rasterizer knows the full set of primitives that contribute to a pixel, the rasterizer can perform full-scene anti-aliasing without incurring extra surface memory cost and/or without the stitching artifacts in per-primitive anti-aliasing. Still further, because each pixel is only written once (and sources are blended at full precision), the pixel color can be converted to lower bit-depths on-the-fly without having to take an extra format conversion pass.

Turning to a consideration of how the rasterizer may be extended to support three-dimensional triangle rasterization, z-information is added to the color buffer, and this information used when merging the virtual geometry data into the color buffer. For three-dimensional content, since the rasterizer knows the triangles that contribute to a pixel, the rasterizer can resolve occlusion without having to use a z-buffer.

More particularly, the state of a triangle (e.g., pixel shader, Gauraud shaded, texture and so forth) corresponds to a primitive, and instead of using a draw order, the triangles are sorted by Z-order. Thus, the above virtual buffer structure and color buffer can be used for three-dimensional triangles, and for purposes of processing data into one or more pixels of a scanline, a triangle can be considered equivalent to a primitive, where appropriate.

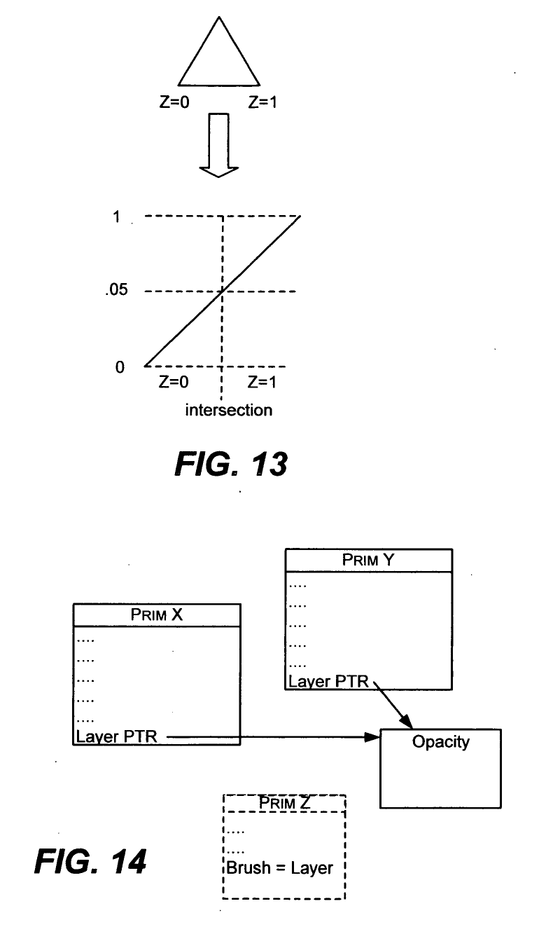

However, a triangle can have its z-order vary, as represented in FIG. 13 where the lower left corner of the triangle has a z-order of 0, and the lower right corner has a z-order of one. As a result of switching z-order within a segment, such information needs to be tracked, and used to end a segment early in order to split the segment data into different nodes. In the example, of FIG. 12, the segment is known to switch z-order halfway, whereby two sub-segments are effectively created from the same triangle texture's segment, one with a z-order of zero for the first half of the segment, and another with a z-order of one half for the second half of the segment. Note that there will only be a need to split the segment if it intersects with another one; thus, the example of FIG. 13 assumes there is another primitive with Z=0.5, whereby the first segment has Z=0 (assuming 0 is closer than 0.5), and the second segment would have Z=0.5 (since 0.5 is closer than 1). As can be readily appreciated, more complex switching may be present in a given triangle, however the concept of having a node for each z-order sub-segment makes it straightforward to perform three-dimensional triangle rasterization.

Another way in which the write-once rasterizer may have extended functionality is to provide support for effects on groups of primitives, such as opacity effects, anti-aliased clip, or other effects. For example, consider applying fifth-percent opacity to a solid blue rectangle above a red rectangle. If their primitives are not treated as a group, the blue and red rectangles would each be made half-transparent, resulting in the blue rectangle becoming purple because it would show some red through it, when what is actually desired was a single blue over red group, with the group half-transparent.

With conventional rasterization, such effects typically required creating and clearing a temporary surface, drawing the primitives (to which the rasterizer will apply the effect) to that surface, drawing a path with that surface selected as a brush to the back buffer with specified effects applied, and discarding the temporary surface. This resulted in very bad performance and memory usage due to overdraw, which could become unacceptable with certain shapes such as a group of slanted rectangles.

With the write-once rasterizer, the rasterizer performs different steps, on each destination scanline rather than for each primitive. In general, each primitive of a group is given a layer identifier that is associated with an opacity value, as generally represented in FIG. 14. Conceptually, the linked list is built once per layer. In this manner, primitives of the same layer may have the same effects applied.

To draw the group, a new primitive is created and introduced with the bounds of the shape for the group, with a brush that corresponds to the layer. Thus, primitive X may have a layer pointer that points to layer 1, as may primitive Y. More particularly, the write-once rasterizer creates a virtual color buffer (Prim Z in FIG. 14) for the group of primitives to which the rasterizer will apply the clip or effect. Note that because the virtual color buffer is a virtual linked structure, the clear can be implemented in constant time.

The rasterizer then draws the primitives into the virtual color buffer, and merges the virtual color buffer into the main color buffer (using the path data as a virtual mask if needed). The color buffer is then rasterized. When rasterizing, the lowest layer (e.g., layer 0) is drawn first. In the event that a segment is determined to have a layer for its brush, as in the path that includes Primitive Z, that brush can be rasterized to a temporary scratch scanline, with effects applied to the temporary scanline. Only the scratch scanline needs to be allocated, rather than a block of memory that bounds an entire primitive.

A still more efficient technique merges pointers to the linked list, although this only applies to certain situations. Consider an example with primitive P1 and P2, and primitive 0 below them, where primitives P1 and P2 are to be drawn with a 0.5 alpha transparency. If primitive P1 is known to be occluded, (e.g., the red is occluded by the solid color blue segment which the rasterizer can determine) the stacks can be merged to essentially eliminate this red segment. If P2 needs to be blended with P1, then the merging cannot be accomplished and the temporary scratch scanline needs to be used.

A key advantage for effects is that the rasterizer can work in virtual buffers, which are on the order of the edge-complexity of the scene, and avoid per-pixel operations as would be required with a surface clear and/or intermediate rasterization. Instead, the rasterizer merges virtual color buffers and rasterizes only once to the back buffer. With respect to group behavior, effects may be applied to groups of primitives on the sources, and written once to the destination memory, without temporary surfaces.

Anti-aliased clipping is another concept, where the clipping occurs between pixel boundaries. In general, the same layer concept for opacity effects is used, with the clip used as the primitive with a temporary surface as the texture. That is, the layer still applies, except the shape used is the clip instead of the bounds of the primitives.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-readable medium having computer-executable instructions, which when executed perform steps, comprising:
adding data to a vector buffer to represent how one or more graphics-related primitives affect a scanline of a set of scanlines that correspond to an image; and
for each scanline affected by at least one primitive, processing the vector buffer to obtain drawing data corresponding to each primitive, and drawing to a destination surface at least a segment of the scanline based on the drawing data.

2. The computer-readable medium of claim 1 wherein adding the data comprises, for each primitive, entering a pointer to a per-primitive data structure at an entry corresponding to the scanline where the primitive that is represented by that per-primitive data structure first enters.

3. The computer-readable medium of claim 2 wherein adding the entries comprises determining for a primitive whether another pointer is already present in the vector buffer, and if so, preserving that other pointer before entering the pointer to the per-primitive data structure into the entry.

4. The computer-readable medium of claim 1 wherein processing the vector buffer to obtain the drawing data comprises, for each scanline, determining a set of one or more primitives that affect that scanline.

5. The computer-readable medium of claim 4 wherein determining the set of one or more primitives that affect that scanline comprises merging information for each primitive that first affects a selected scanline with information of any other primitive that first affected an earlier scanline without having ended before the selected scanline.

6. The computer-readable medium of claim 1 wherein processing the vector buffer to obtain the drawing data comprises combining the drawing data of at least two primitives.

7. The computer-readable medium of claim 1 wherein processing the vector buffer to obtain the drawing data comprises determining whether the drawing data of a higher drawing-ordered primitive occludes the drawing data of a lower drawing-ordered primitive, and if so, drawing using only the drawing data of the higher-ordered primitive.

8. The computer-readable medium of claim 1 wherein processing the vector buffer to obtain the drawing data corresponding to each primitive comprises determining one or more segments that make up the scanline.

9. The computer-readable medium of claim 8 wherein each primitive corresponds to a triangle that is associated with z-order data, and wherein processing the vector buffer to obtain the drawing data comprises determining one or more segments that make up the scanline, including determining any sub-segments based on the z-order information of the triangle and at least one other triangle.

10. The computer-readable medium of claim 1 wherein processing the vector buffer to obtain the drawing data corresponding to each primitive comprises applying an effect to the drawing data of a group of at least two primitives.

11. The computer-readable medium of claim 1 wherein processing the vector buffer to obtain the drawing data corresponding to each primitive comprises determining anti-alias data for a primitive with respect to at least an edge of a segment of the scanline.

12. The computer-readable medium of claim 11 having further computer-executable instructions comprising, constructing a set of sub-scanline locations for maintaining drawing data based on the anti-alias data of the primitive.

13. The computer-readable medium of claim 11 having further computer-executable instructions comprising, constructing a coverage buffer for maintaining drawing data based on the anti-alias data of the primitive.

14. In a computing environment having a device that displays, transfers or prints graphics-related data, a system comprising:
a rasterizer, the rasterizer including:
a first mechanism that processes a set of graphics primitives into entries into a vector buffer, the vector buffer comprising an array of entries with each entry representing a scanline where a primitive at least first affects the set of scanlines that correspond to an image; and
a second mechanism that processes the vector buffer to determine which primitive or primitives affect a selected scanline, and for the selected scanline, to draw pixels for the scanline by processing drawing information associated with each primitive that affects that scanline.

15. The system of claim 14 wherein the second mechanism draws the pixels for the scanline by processing the drawing information into one or more segments based on edge data corresponding to the primitive or primitives that affect the scanline.

16. The method of claim 15 wherein the second mechanism maintains a data structure containing anti-alias data for at least one primitive of at least one segment based on the edge data.

17. The method of claim 15 wherein the data structure comprises at least one data structure of a set, the set containing a coverage buffer and a set of sub-segment locations.

18. In a computing environment, a method comprising:
(a) storing data that references a selected graphics-related primitive of a set of primitives that make up a graphics image, the stored data enabling drawing information corresponding to the primitive to be located via the data;
(b) repeating (a) until each primitive that makes up the image may be referenced via its stored data;
(c) selecting a scanline as a selected scanline;
(d) drawing the selected scanline to a destination surface by determining from the stored data which set of one or more primitives affect that selected scanline, and using the drawing information associated with each primitive along with relative ordering data to determine how data should be output for at least one set of one or more pixels of the selected scanline; and
(e) selecting a previously non-selected scanline as the selected scanline and repeating steps (d) and (e) until no non-selected scanline remains to be selected.

19. The method of claim 18 wherein drawing the selected scanline to the destination surface comprises determining segment information based on edge data corresponding to the set of one more primitive or primitives that affect the selected scanline.

20. The method of claim 19 wherein at least two primitives affect a segment determined from the segment information, and wherein using the drawing information associated with each primitive along with the relative ordering data to determine how data should be output comprises using brush information associated with each of the at least two primitives.
